(19) United States
(12) Patent Application Publication
(10) Pub. No.: US 2004/0132426 A1
(43) Pub. Date: Jul. 8, 2004

(54) Method for controlling a mobile terminal and mobile terminal

(76) Inventor: Stefan Baiker, Basel (CH)

Correspondence Address: OLIFF & BERRIDGE, PLC, P.O. BOX 19928, ALEXANDRIA, VA, 22320, US

(21) Appl. No.: 10/481,422

(22) PCT Filed: Jul. 2, 2001
(86) PCT No.: PCT/CH01/00410

(51) Int. Cl. H04Q 7/20

(52) U.S. Cl. 455/403

(57) ABSTRACT

The inventive method allows to control a mobile wireless terminal such as a cordless or a cellular mobile station in order to limit or completely avoid disturbances the mobile terminal may cause during the receipt of a call which is a first or a second stage is acoustically or mechanically signalled to the user of the mobile terminal, comprising the steps of detecting a mechanical stimulus at least during the time an incoming call is signalled, stopping acoustical or mechanical signalling in case that a mechanical stimulus is detected and subsequently signalling the incoming call by emission of optical signals or automatically accepting the call and sending a recorded message to the calling party or switching the mobile wireless terminal off.

The present invention relates to a method for controlling a mobile wireless terminal such as a cordless or a cellular mobile station and a mobile wireless terminal according to claim 1 and claim 8.

The present invention relates in particular to a method for controlling a mobile wireless terminal during the setup of a call. More particularly the present invention relates to a method for controlling a wireless terminal in order to limit or completely avoid disturbing ringing signals.

The present invention further relates to a mobile wireless terminal such as a cordless or a cellular mobile station which can be controlled in such a way that disturbing ringing signals are limited or completely avoided.

### BACKGROUND OF THE INVENTION

Mobile wireless terminals such as cordless or cellular mobile stations have become the companion in daily life which allow to reach their owners whenever and wherever they are.

A call may in some situations however disturb the owner of the mobile terminal or third parties. In [1], WO 00/76235 it has therefore been proposed to minimize or completely remove the possibility of using a mobile terminal in certain places. In the proposed system a stand-alone device is arranged to force a mobile station entering a restricted area to register in the system. The stand-alone device issues a message to the mobile station instructing the user to turn the mobile station off, when the area, which is covered by the stand-alone device, is entered.

Switching a mobile station completely off in the situations described above may however also be undesirable since in an emergency situation an owner of a mobile station must be reachable despite of a disturbance which might be caused. In addition, systems, as described in [1], are not widespread and require maintenance since communication over a mobile terminal may be undesirable only for certain time periods, for example during a performance in a concert hall, while communication over the mobile terminal before or after the performance may be allowed.

Furthermore an owner of a mobile station may enter a restricted area, such as a conference room, only for a short time period for which he would not want to switch the mobile station off and on again.

It would therefore be desirable to provide a method for controlling a mobile terminal such as a cordless or a cellular mobile station in order to limit or completely avoid disturbances the mobile terminal may cause during the receipt of a call, while the owner of the mobile terminal can still respond to the call.

It would be desirable in particular to provide a method which allows the owner of the mobile station or another person to control the mobile station quickly and easily, i.e. without entering any key functions or performing other specific operations.

It would further be desirable to design said method in such a way that it can be implemented in a mobile terminal with none or only few hardware changes required therein.

It would further be desirable to create a mobile terminal such as a cordless or a cellular mobile station which can be controlled in such a way that disturbing ringing signals are limited or completely avoided.

### SUMMARY OF THE INVENTION

The above and other objects of the present invention are achieved by a method and a mobile terminal according to claim 1 and claim 8 respectively.

The inventive method allows to control a mobile wireless terminal such as a cordless or a cellular mobile station in order to limit or completely avoid disturbances the mobile terminal may cause during the receipt of a call which in a first or a second stage is acoustically or mechanically signalled to the user of the mobile terminal.

In case that the mobile terminal is enclosed in a bag or pocket the user needs only to hit said bag or pocket in order to mute the terminal.

A mobile wireless terminal, which is designed to communicate over transmission channels with further voice and/or data terminals, comprises a control unit, a memory unit storing an operating system, a keyboard, a display, communication modules and means designed for acoustically signalling a call incoming from one of said further terminals such as a loudspeaker.

According to the present invention a shock sensor or a sensor, such as a microphone or a vibration sensor, which transforms acoustical or mechanical waves into electrical signals, is connected to the control unit, which is programmed

a) to detect a mechanical stimulus based on signals received from said sensors at least during the time an incoming call is signalled;

b) to stop acoustical or mechanical signalling in case that a mechanical stimulus is detected and subsequently

c1) to switch the system to a status in which incoming calls are exclusively signalled by optical means or

c2) to automatically accept the call and to send a recorded message to the calling party or

c3) to switch the system off

c3-1) instantaneously or

c3-2) after receipt of a further mechanical stimulus.

The user of a mobile terminal can therefore control the mobile terminal during the time an incoming call is signalled by applying a mechanical stimulus to the terminal. For example the user can knock directly onto the terminal or give a push towards the terminal which may be enclosed in a bag or pocket, thus accelerating the terminal or causing acoustical or mechanical waves which can be sensed by the microphone, a vibration sensor and/or a shock or acceleration sensor which is preferably sensitive to rotational shocks and/or linear shocks along different axes.

In order to sense a shock or a mechanical stimulus a standard mobile wireless terminal may be enhanced with a sensor such as a shock sensor as disclosed in [2], U.S. Pat. No. 6,031,317. Adding additional circuitry including a shock sensor would however cause extra costs which would partially offset advantages derived by implementation of the invention.

In a preferred embodiment the invention uses components as sensors which are already incorporated in a standard mobile wireless terminal.

In one preferred embodiment the mechanical stimulus, which causes the terminal or its casing to resonate and therefore to emit acoustical and/or mechanical waves, is sensed by the same microphone which is used after the setup of a call for communication purposes and which for this reason is already incorporated in the mobile terminal.

In a further embodiment a modified microphone is used comprising at least one elastically suspended element which during a mechanical stimulus is contacting

a) a second element thereby generating acoustical waves or

b) the membrane of the microphone thereby inducing a voltage in the voice coil connected to the membrane or

c) a solid part of the microphone such as a yoke thereby generating acoustical and mechanical waves.

Therefore, a mobile terminal suitable for the application of the inventive method scarcely differs from a standard mobile terminal. Thus the invention can be implemented by the use of a modified microphone and the installation of an operating system adapted accordingly thereby incurring only marginal extra cost.

In order to avoid incorrect detections, the electrical signals received from the microphone are preferably filtered so that for example ringing signals are suppressed. Preferably the filter is tuned to frequencies in the range of the resonant frequency of the mobile terminal, the casing of the mobile terminal or waves generated by elements of the sensors after the occurrence of a mechanical stimulus.

In a second preferred embodiment the mechanical stimulus is sensed by a device designed for generating calling vibrations such as the device described in [3], U.S. Pat. No. 5,956,622. Said device comprises a magnet system and a coil which are elastically suspended and movable relative to each other. In case that during a call setup a low frequency signal is applied to the coil then the magnet system will start to vibrate thus emitting calling vibrations which are practically not audible. In case that an incoming call is acoustically signalled then the mechanical stimulus can be detected by said device acting as vibration sensor. A movement of the magnet system caused by a mechanical stimulus will therefore induce a voltage in the coil which can be detected by the control unit preferably by comparing the received signals with a fixed or adjustable treshold value.

Thus the invention can also be implemented by the use of a device designed for generating calling vibrations, which is installed in standard mobile terminals, and the installation of an operating system adapted accordingly thereby incurring only marginal extra cost.

### BRIEF DESCRIPTION OF THE DRAWINGS

Some of the objects and advantages of the present invention have been stated, others will appear when the following description is considered together with the accompanying drawings, in which:

FIG. 1 shows the architectural overview of a cordless terminal which is equipped with a shock sensor 30;

FIG. 2 shows the architectural overview of a cellular mobile station equipped with a device which is designed to emit calling vibrations and to sense a mechanical stimulus;

FIG. 3a shows a microphone 10a equipped with elements 106a which transform the mechanical stimulus into acoustical signals;

FIG. 3b shows a microphone 10b equipped with an element 106b which, subsequent to a mechanical stimulus, contacts the membrane 103 of the microphone 10b;

FIG. 3c shows a microphone 10c equipped with an element 106b which, subsequent to a mechanical stimulus, contacts the yoke 104 of the microphone 10c;

FIG. 4 shows a flow diagram with steps sequentially performed after an inventive mobile terminal has received an incoming call.

### DETAILED DESCRIPTION OF THE PREFERRED EMBODIMENTS

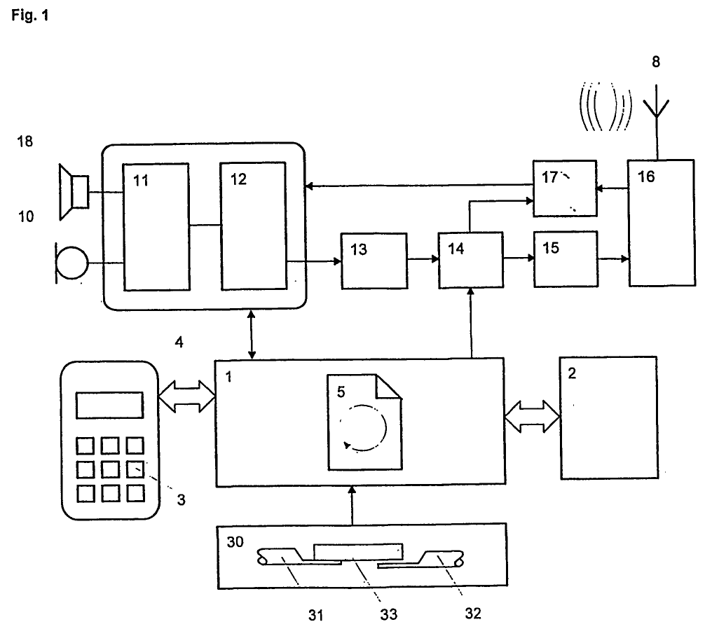

FIG. 1 shows the architectural overview of an inventive cordless terminal which is operating for example according to the DECT (Digital European Cordless Telephone) standard as described in [4], Jerry D. Gibson, THE COMMUNICATIONS HANDBOOK, CRC PRESS, Boca Raton 1997, chapter 92, pages 1305-1325 (see page 1309, FIG. 92.4).

The terminal shown in FIG. 1 comprises a control unit 1, a memory unit 2 in which an operating system 5 is stored, a keyboard 3, a display unit 4, a microphone 10, a loudspeaker 18 and communication modules such as a modulator 13, an RF synthesizer 14, an RF transmitter 15, an RF switch 16, an antenna 8, an RF receiver 17 and, operating in the digital baseband, an audio codec 11 and a transcoder 12. The functions of the these modules are described in [4], chapter 92, pages 1305-1325. Calls incoming at the terminal are acoustically signalled by means of the loudspeaker 18.

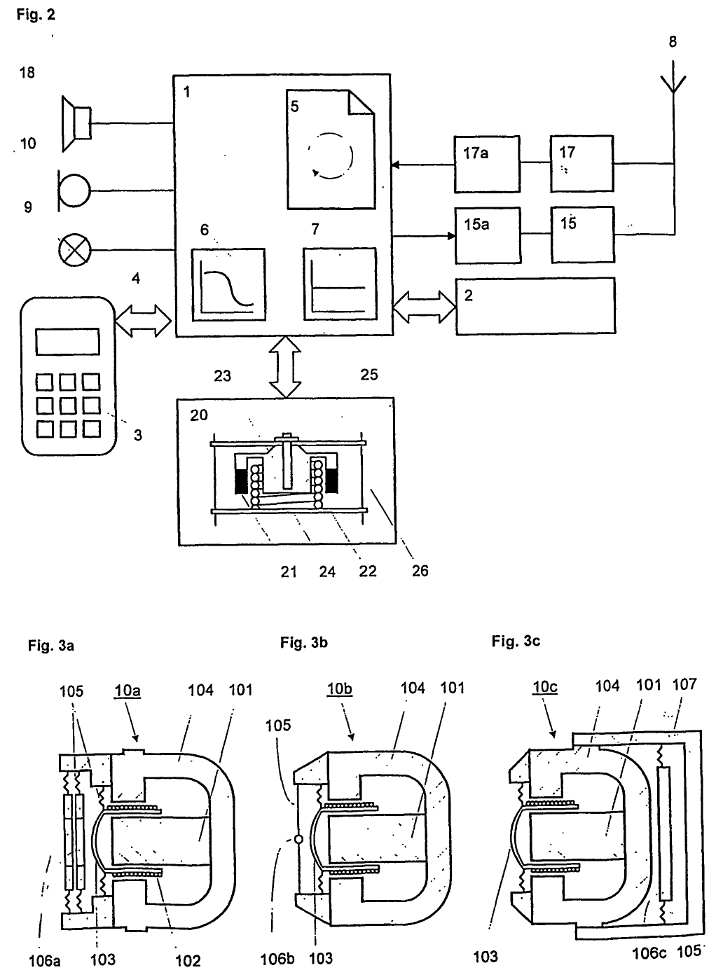

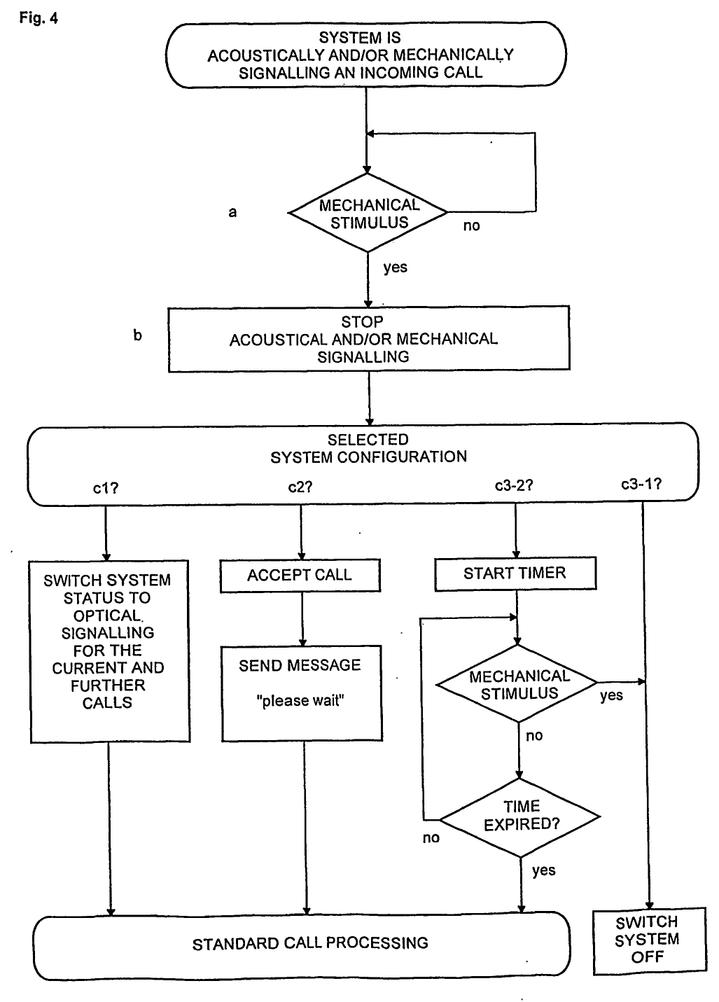

FIG. 4 shows a flow diagram with steps sequentially performed after an inventive mobile terminal, such as the ones shown in FIG. 1 and FIG. 2, has received an incoming call.

According to the present invention a sensor 30, which is capable to detect a mechanical stimulus, is connected to the control unit 1, which is programmed

a) to detect a mechanical stimulus based on signals received from said sensor 30 at least during the time an incoming call is signalled,

b) to stop acoustical or mechanical signalling in case that a mechanical stimulus is detected and subsequently

c1) to switch the system to a status in which incoming calls are exclusively signalled by optical means such as a light emitting diode 9 or

c2) to automatically accept the call and to send a recorded message to the calling party or

c3) to switch the mobile terminal off

c3-1) instantaneously or

c3-2) after receipt of a further mechanical stimulus.

In a preferred embodiment, in the case the user has configured the system to operate according to option c3-2 (see FIG. 4), a second mechanical stimulus may be applied within a defined time period, i.e. within a few seconds, which causes the system to switch the mobile terminal off completely.

A soon as a call is signalled a ringing tone will be produced by the mobile terminal as described for example in [8], U.S. Pat. No. 5,452,354. According to the present invention the user of the mobile terminal may avoid further disturbances by applying a mechanical stimulus to the mobile terminal which is sensed by the control unit 1 as described above.

Since the inventive steps are performed only during a short period of time when an incoming call is signalled the system may be adjusted to detect very small mechanical stimuli. Preferably the sensitivity level is adjustable by the user of the mobile terminal.

The user of the mobile terminal thus has the choice of muting the terminal, during receipt of a call or to respond to the call. A user who has forgotten to switch off the mobile terminal and receives a call, for example during a concert, can hence mute his mobile terminal instantaneously.

After a mechanical stimulus had been detected and acoustical signalling had been stopped, the control unit 1 may, as configured by a user, continue signalling of the incoming call by emission of optical signals thus avoiding disturbing third parties while the user, for example in case that an emergency number is shown on the display 4, may still accept the call.

A user may however also select automatic acceptation of the call after which a recorded message is sent to the calling party. Preferably the calling party may respond with a message which is recorded and stored in the memory 2. In a preferred embodiment of the invention the call is automatically accepted and a message is sent informing the calling party that the called subscriber will answer the call in a minute. While the calling party is waiting, the called subscriber may look for a convenient place before beginning the communication over the phone.

In many cases a user will be glad to stop ringing immediately without responding to the call. In such a case a mode is selected by which the mobile terminal, after receipt of

C3-1) a first or

C3-2) a second mechanical stimulus,

is switched off instantaneously.

A user may also prefer that a call is signalled in a first stage by emission of optical signals for a pre-defined time period and in a second stage, in case that no mechanical stimulus is detected during this time period, signalling is subsequently continued by emission of acoustical signals. This configuration is not shown in FIG. 4.

In this mode a user can decide whether he wants to accept the call or to avoid a disturbance. During a meeting the user may see optical signals which indicate an incoming call. By knocking onto the mobile terminal the incoming call can be treated as described above thus avoiding a disturbance of the participants of the meeting.

The implementation of the invention is of course not limited to mobile terminals as described above. The invention can for example be implemented in all terminals of the so called second generation mobile communication systems which are described in [4], chapter 86, pages 1208-1225.

FIG. 2 shows the architectural overview of a cellular mobile station, which is operating for example according to the standards of the Pan-European Cellular System known as GSM which is described in [4], chapter 87 (see Introduction and Overview on pages 1226-1228).

The terminal shown in FIG. 2 comprises a control unit 1, a memory unit 2 in which an operating system 5 is stored, a keyboard 3, a display unit 4, a microphone 10, a loudspeaker 18, a light emitting diode 9 and communication modules such as a modulator 15a, an RF transmitter 15, an antenna 8, an RF receiver 17 and a demodulator 17a. These modules are described in [5], U.S. Pat. No. 5,887,254.

The terminal shown in FIG. 2 further comprises a device 20 for generating calling vibrations or calling sounds as described in [3], U.S. Pat. No. 5,956,622.

The mechanical stimulus which is detected by the control unit 1 of the mobile wireless terminals shown in FIG. 1 and FIG. 2 can be sensed by various sensors such as shock sensors 30 or by sensors which transform acoustical or mechanical waves into electrical signals.

As shown in FIG. 1 a shock sensor 30 may be added to the terminal which is not used for the basic functions of a mobile wireless terminal.

However the integration of additional elements would increase the costs of the terminal. Therefore in a preferred embodiment of the invention physical transducers which are already integrated in a standard mobile wireless terminal are used as sensors in order to detect a mechanical stimulus.

Sensors which are capable to detect a mechanical stimulus are described in [6], Richard C. Dorf, THE ELECTRICAL ENGINEERING HANDBOOK, CRC Press LLC, Boca Raton 1997, chapter 56, pages 1255-1259. These sensors may use single or multiple transduction mechanisms based on piezoelectricity, piezoresistivity, or resistive, capacitive or inductive effects. As detailed below the mechanical stimulus may be transduced into acoustical waves which are further transduced by the microphone into electrical signals. The mechanical stimulus may also move a magnet relative to a coil, or vice versa, inducing therein a voltage.

The sensor may be a shock sensor as described in [2], U.S. Pat. No. 6,031,317 or [7], U.S. Pat. No. 6,142,007 which uses a piezoelectric effect or which comprises an elastically supported weight member which is used to close a contact whenever the sensor is accelerated.

The mobile terminal shown in FIG. 2 comprises two different transducers which can be used practically without modification for sensing mechanical stimuli applied to the mobile terminal. A mechanical stimulus applied to the mobile terminal causes mechanical and acoustical waves which, during the setup of a call, can be sensed by the microphone 10 which, after connection has been established, is used for communication purposes.

Basic procedures for setting up a call are described for example in [9], P. Bocker, ISDN-Digitale Netze für Sprach-, Text-, Daten-, Video- und Multimediakommunikation, 4. Auflage, Springer Verlag, Berlin 1997, page 127, FIG. 4.27. In GSM systems, the setup procedure starts when the gateway GMSC of a mobile switching center MSC receives an ISUP IAM message from a remote network. The gateway GMSC must then ask the corresponding home location register HLR for a roaming number using procedures of the mobile application part (MAP) of the Signalling System No. 7. Further, the home location register HLR sends this request to the visitor location register VLR, which assigns a roaming number to the IMSI in question, and returns it. The gateway GMSC can now forward the call setup request (IAM) to the mobile switching center MSC the mobile station MS in question is registered with. When the setup between the mobile switching center MSC and the mobile station MS is finished, the user is alerted (the mobile terminal is ringing) and a notification of this is sent to the caller via an ISUP ACM message. When the receiver accepts the call, an ISUP ANU message is sent to the caller, and the connection is established.

In inventive mobile terminals operating according to GSM-recommendations, mechanical stimuli are therefore preferably sensed between the time the setup of a connection between a mobile switching center MSC and the mobile terminal MS has been completed and the time the receiver/called party accepts the call.

A mechanical stimulus caused by an acceleration of the mobile terminal may in certain cases generate acoustical signals which are to small to be detected. In preferred embodiments of the invention mechanical stimuli are therefore transduced with modified microphones in such a way that mechanical stimuli can reliably be detected even in cases when the mobile terminal is enclosed in a bag or pocket.

FIGS. 3a, 3b and 3c show electrodynamic microphones 10a, 10b, 10c comprising a magnet 1001 connected to a yoke 104 and a coil 102 connected to the membrane. The invention can however be realised with any other microphone comprising a membrane 103.

FIG. 3a shows a microphone 10a equipped with two metallic elements 106a which are elastically suspended in front of the membrane 103 by means of elastic elements 105. Said suspended elements 106a are designed and mounted in such a way that they will get in contact whenever a mechanical impact occurs thus generating acoustical waves which can easily be sensed by the microphone 10a.

FIG. 3b shows a microphone 10b equipped with one element 106b which is elastically suspended in front of the membrane 103 by means of elastic elements 105 in such a way that the element 106b will get in contact with the membrane 103 whenever a mechanical impact occurs thus mechanically causing a movement of the membrane 103 and a corresponding induction of electrical signals in the coil 102, which can easily be detected by the control unit 1.

FIG. 3c shows a microphone 10c equipped with one element 106c which is elastically suspended in front of the yoke 104 by means of elastic elements 105 provided in a holding element 107 in such a way that the element 106b will get in contact with the yoke 104 whenever a mechanical impact occurs thus causing acoustical and mechanical waves which will move the coil 102 to relative to the magnet thus inducing electrical signals in the coil 102, which can easily be detected by the control unit 1.

Thus the invention can be implemented by the use of a modified microphone and the installation of an operating system adapted accordingly thereby incurring only marginal extra cost.

Besides acoustical waves caused by a mechanical stimulus the microphone will also receive different sounds such as the ringing signals emitted by the loudspeaker 18. In order to suppress signals which could lead to incorrect detections, in a preferred embodiment of the invention, the control unit 1 comprises a filter module 6 which suppresses frequencies particularly in the range of ringing signals and/or which passes only frequencies in the range of acoustical signals which may be caused by a mechanical stimulus. The filter module 6 may therefore be tuned to the resonant frequency of the mobile terminal, or parts thereof such as the casing, elements of the microphone or said elastically suspended elements 106a.

In order to further avoid incorrect detections the electrical signals received are preferably compared with a fixed or adjustable threshold value in a comparator module 7 of the control unit 1. The user of a mobile terminal can therefore adjust the treshold level according to his personal conditions for example the ambient noise or the kind of mechanical stimuli usually applied.

Modern mobile terminals are often equipped with devices 20 (see FIG. 2) designed for generating calling vibrations such as the device described in [3], U.S. Pat. No. 5,956,622. Said device comprises a magnet system 21 including a magnet and a yoke 23 and a coil 22 which are elastically suspended, within a cylinder 26 by means of vibration members 24, 25, and movable relative to each other. In case that during a call setup a low frequency signal is applied to the coil 22 then the magnet system 21 will start to vibrate thus emitting calling vibrations which are practically not audible. In case that an incoming call is acoustically signalled then a mechanical stimulus, applied to mute the terminal, can be detected by said device acting as vibration sensor 20. A movement of the magnet system 21 caused by a mechanical stimulus will therefore induce a voltage in the coil 22 which can be detected by the control unit I preferably by comparing the received signals with a fixed or adjustable treshold value.

Thus the invention can also be implemented by the use of a device designed for generating calling vibrations, which is installed in standard mobile terminals, and the installation of an operating system adapted accordingly thereby incurring only marginal extra cost.

References

[1] International Publication WO 00/76235

[2] U.S. Pat. No. 6,031,317

[3] U.S. Pat. No. 5,956,622

[4] Jerry D. Gibson, THE COMMUNICATIONS HANDBOOK, CRC PRESS LLC, Boca Raton 1997

[5] U.S. Pat. No. 5,887,254

[6] Richard C. Dorf, THE ELECTRICAL ENGINEERING HANDBOOK, CRC Press LLC, Boca Raton 1997

[7] U.S. Pat. No. 6,142,007

[8] U.S. Pat. No. 5,452,354

[9] P. Bocker, ISDN-Digitale Netze für Sprach-, Text-, Daten-, Video- und Multimediakommunikation, 4. Auflage, Springer Verlag, Berlin 1997

1. Method for controlling a mobile wireless terminal such as a cordless or a cellular mobile station in order to limit or completely avoid disturbances the mobile terminal may cause during the receipt of a call which in a first or a second stage is acoustically or mechanically signalled to the user of the mobile terminal, comprising the steps of
a) detecting a mechanical stimulus at least during the time an incoming call is signalled;
b) stopping acoustical or mechanical signalling in case that a mechanical stimulus is detected and subsequently
c1) switching the system to a status in which incoming calls are exclusively signalled by optical means or
c2) automatically accepting the call and sending a recorded message to the calling party or
c3) switching the mobile wireless terminal off
c3-1) instantaneously or
c3-2) after receipt of a further mechanical stimulus.

2. Method according to claim 1, in which the incoming call is automatically accepted, a recorded message is sent to the calling party and the call is answered by the called patty after a while as indicated in said message or a message from the calling party is recorded before the call is terminated.

3. Method according to claim 1 or 2, in which a call is signalled by emission of optical signals for a pre-defined time period and, in case that no mechanical stimulus is detected during this time period, signalling is subsequently continued by emission of acoustical signals.

4. Method according to claim 1, 2 or 3, in which a mechanical stimulus is detected by a shock sensor (30) or by a sensor (10; 10a; 10b; 10c; 20) which transforms acoustical or mechanical waves into electrical signals.

5. Method according to claim 4, with a mobile terminal comprising a microphone which is used as acoustical sensor (10; 10a; 10b; 10c) and/or with a device for generating calling vibrations which is used as vibration sensor (20).

6. Method according to claim 4 or 5, in which the electrical signals provided by the microphone (10; 10a; 10b; 10c) are filtered thereby suppressing frequencies in the range of ringing signals and/or passing only frequencies in the range of acoustical signals which may be caused by a mechanical stimulus.

7. Method according to claim 4, 5 or 6, in which the electrical signals provided by the sensor (10; 10a; 10b; 10c; 20) are compared with a fixed or adjustable threshold value.

8. Mobile wireless terminal such as a cordless or a cellular mobile station designed to communicate over transmission channels with further voice and/or data terminals comprising a control unit (1), a memory unit (2) storing an operating system (5), a keyboard (3), a display unit (4), communication modules (11, . . . , 17) and means (18) designed for acoustically or mechanically signalling a call incoming from one of said further terminals such as an electromechanical transducer (18; 20, 24), characterised in that a shock sensor (30) or a sensor (10; 10a; 10b; 10c; 20), which transforms acoustical or mechanical waves into electrical signals, is connected to the control unit (1) which is programmed
a) to detect a mechanical stimulus based on signals received from said sensor (10; 10a; 10b; 10c; 20; 30) at least during the time an incoming call is signalled;
b) to stop acoustical or mechanical signalling in case that a mechanical stimulus is detected and subsequently.
c1) to switch the system to a status in which incoming calls are exclusively signalled by optical means such as a light emitting diode (9) for non-acoustical signalling or
c2) to automatically accept the call and to send a recorded message to the calling party or
c3) to switch the mobile wireless terminal off
c3-1) instantaneously or
c3-2) after receipt of a further mechanical stimulus.

9. Mobile wireless terminal according to claim 8, in which the control unit (1) is programmed to automatically accept incoming calls, to send a recorded message to the calling party and to keep the call on hold or to record a message from the calling party before the call is terminated.

10. Mobile wireless terminal according to claim 8 or 9, with a microphone (10) used for communication purposes and as sensor (10; 10a; 10b; 10c) which transforms acoustical or mechanical waves into electrical signals and/or a device (20) for generating calling vibrations which is used as vibration sensor (20) which transforms mechanical waves into electrical signals.

11. Mobile wireless terminal according to claim 10, with at least one element (106a; 106b; 106c) elastically connected to the microphone (10a; 10b; 10c) which during a mechanical stimulus is contacting
a) a second element (106a) thereby generating acoustical waves or
b) the membrane (103) of the microphone (10b) thereby inducing a voltage in the coil (102) connected to the membrane (103) or
c) a solid part of the microphone (10b) such as a yoke (107) thereby generating acoustical and mechanical waves.

12. Mobile wireless terminal according to one of the claims 8-11, in which the control unit (1) comprises a filter module (6) designed to filter electrical signals received from the microphone (10; 10a; 10b; 10c) thereby suppressing frequencies in the range of ringing signals and/or passing only frequencies in the range of acoustical signals which may be caused by a mechanical stimulus.

13. Mobile wireless terminal according to one of the claims 8-12, with a comparator (7) designed to compare the electrical signals provided by the microphone (10; 10a; 10b; 10c) or the vibration sensor (20) with a fixed or adjustable threshold value.
